(19) United States
(12) Patent Application Publication
(10) Pub. No.: US 2016/0080674 A1
(43) Pub. Date: Mar. 17, 2016

(54) Method and control unit for operating an image sensor

(71) Applicant: Robert Bosch GmbH, Stuttgart, DE (US)

(72) Inventor: Michael HADELER, Pliezhausen (DE)

(21) Appl. No.: 14/846,056

(22) Filed: Sep. 4, 2015

(30) Foreign Application Priority Data
Sep. 17, 2014 (DE) 10 2014 218 627.7

(51) Int. Cl. H04N 5/378

(52) U.S. Cl. CPC H04N 5/378

(57) ABSTRACT

A method for operating an image sensor, which has pixels arranged in rows and columns, includes the read-out, in which pixels of a first subarea of the image sensor are read out to obtain a first item of subimage information using a first parameter set, and in which pixels of at least one second subarea of the image sensor are read out to obtain a second item of subimage information using a second parameter set, which is different from the first parameter set.

### RELATED APPLICATION INFORMATION

The present application claims priority to and the benefit of German patent application no. 10 2014 218 627.7, which was filed in Germany on Sep. 17, 2014, the disclosure of which is incorporated herein by reference.

### FIELD OF THE INVENTION

The present invention relates to a method for operating an image sensor, a corresponding control unit, and a corresponding computer program.

### SUMMARY OF THE INVENTION

A method for operating an image sensor, furthermore a control unit which uses this method, and finally a corresponding computer program according to the main claims are provided by the approach introduced here. Advantageous embodiments result from the particular descriptions herein and the following description.

In an image sensor, incident light on a pixel of the image sensor results in an electrical charge of the pixel. The electrical charge is read out in an electrical signal. The electrical signal has a greater value the more light is incident on the pixel.

During the read-out of the electrical charge, a value of the electrical charge may be converted via a nonlinear function into the value of the electrical signal.

When the image sensor is to depict a bright scene, the pixels of the image sensor are exposed using a short exposure time.

When the image sensor is to depict a dark scene, a long exposure time is used. A scene in which both bright areas and also dark areas are to be depicted may overburden a dynamic scope of the image sensor. The bright area is then either depicted excessively bright or the dark area is depicted excessively dark.

To prevent this, in the approach introduced here, the bright area is exposed using a shorter exposure time than the dark area. Furthermore, the nonlinear function may be adapted to convert the value of the electrical charge into the value of the electrical signal.

In particular, a subarea of the image sensor, in which bright areas are expected, is exposed using a short exposure time. Vice versa, a subarea of the image sensor, in which dark areas are expected, is exposed using a long exposure time.

A method for operating an image sensor is provided, the image sensor including pixels arranged in rows and columns, and the method including a step of the read-out, in which pixels of a first subarea of the image sensor are read out, to obtain a first item of subimage information using a first parameter set, and in which pixels of at least one second subarea of the image sensor are read out to obtain a second item of subimage information using a second parameter set, which is different from the first parameter set.

An image sensor may be understood as a CMOS sensor. The image sensor may have a matrix of pixels. The matrix may be divided into subareas. The subareas may overlap. An item of subimage information may be an item of image information of a subarea. A parameter set may characterize a transfer function of incident light into image information.

The pixels of the first and/or second subarea may be read out in rows. The read-out of a last row of the first subarea may be ended chronologically after a beginning of the read-out of a first row of the second subarea. Alternatively, the read-out of a second row of the first subarea may be ended chronologically after an end of the read-out of the first row of the second subarea. The beginning and alternatively or additionally the end of the read-out may each be offset by the time step. The read-out per se may take place in parallel. The rows of the subareas may each directly adjoin one another. Alternatively, in each case one row may be associated with one subarea and the adjacent row may be associated with the other subarea.

The first parameter set may represent at least one first exposure time for the pixels of the first subarea and/or at least one first sensitivity characteristic curve for the pixels of the first subarea. The second parameter set may represent at least one second exposure time for the pixels of the second subarea and/or at least one second sensitivity characteristic curve for the pixels of the second subarea. The exposure time and the sensitivity characteristic curve characterize the transfer function between the electrical charge induced by the incident light and the signal value of the electrical signal, which is an integral part of the image information. Different light conditions in the subareas may be reacted to by way of the different parameter sets.

The first subarea may be read out using a first number of rows. The second subarea may be read out using a second number of rows. The first number of rows and the second number of rows may be variable for the specific application. The first subarea may be read out using a first number of columns. The second subarea may be read out using a second number of columns. The first number of columns and the second number of columns may be variable for the specific application. In other words, a size of the subareas may be varied to react to changed light conditions and/or changed situations.

The first item of subimage information and the second item of subimage information may be joined to form one item of image information. The items of subimage information may combine to form an overall item of image information. Alternatively, subareas of the image sensor may not be used. The image information may be provided in a common file format for further applications.

The image sensor may be read out cyclically, to obtain an item of image information. An image stream may be assembled using a plurality of items of image information. The read-out of a last row of a preceding item of image information of the image stream may be started before the read-out of a first row of a subsequent item of image information of the image stream. The read-out of the last row of a preceding item of image information may be stopped after starting the read-out of the first row of the subsequent item of image information. In other words, following a last row of the image sensor, the first row of the image sensor may be read out again. The preceding item of image information may be read out using the first parameter set and at least the second parameter set. The subsequent item of image information may be read out using a further first parameter set and at least one further second parameter set. Changed requirements may thus be reacted to.

The approach introduced here furthermore provides a control unit for operating an image sensor, which is configured to carry out, activate, or implement the steps of a variant of a method provided here in corresponding devices. The object on which the present invention is based may also be achieved rapidly and efficiently by this embodiment variant of the present invention in the form of a control unit.

A control unit may be understood in the present case as an electrical device, which processes sensor signals and outputs control signals and/or data signals as a function thereof. The control unit may have an interface, which may be configured as hardware and/or software. In the case of a hardware configuration, the interfaces may be part of a so-called system ASIC, for example, which contains greatly varying functions of the control unit. However, it is also possible that the interfaces are separate, integrated circuits or are made at least partially of discrete elements. In the case of a software configuration, the interfaces may be software modules, which are present on a microcontroller in addition to other software modules, for example.

Furthermore, an image sensor including a control unit according to the approach introduced here is provided. The control unit is connected to a sensor surface of the image sensor and is configured to activate the image sensor.

A computer program product or computer program is also advantageous, having program code, which may be stored on a machine-readable carrier or storage medium such as a semiconductor memory, a hard drive memory, or an optical memory and is used to carry out, implement, and/or activate the steps of the method according to one of the above-described specific embodiments, in particular if the program product or program is executed on a computer or a device.

The approach introduced here will be explained in greater detail hereafter as an example on the basis of the appended drawings.

### BRIEF DESCRIPTION OF THE DRAWINGS

FIG. 1 shows a block diagram of an image sensor including a control unit for operating the image sensor according to one exemplary embodiment of the present invention.

FIG. 2 shows a representation of a sequence for generating an image stream using various exposure characteristic curves.

FIG. 3 shows a representation of an image stream made of three items of image information read out successively according to one exemplary embodiment of the present invention.

FIG. 4 shows a chronological sequence of an activation of an image sensor according to one exemplary embodiment of the present invention.

FIG. 5 shows a representation of an image stream including overlapping subareas according to one exemplary embodiment of the present invention.

FIG. 6 shows a chronological sequence of an activation of an image sensor using multiple exposure according to one exemplary embodiment of the present invention.

FIG. 7 shows a chronological sequence of an activation of an image sensor using virtual rows according to one exemplary embodiments of the present invention.

FIG. 8 shows a chronological sequence of an activation of an image sensor using blank rows according to one exemplary embodiment of the present invention.

FIG. 9 shows a chronological sequence of an activation of an image sensor using a multiple exposure of an object area according to one exemplary embodiment of the present invention.

FIG. 10 shows a flow chart of a method for operating an image sensor according to one exemplary embodiment of the present invention.

FIG. 11 shows a representation of an object in an item of image information according to one exemplary embodiment of the present invention.

FIG. 12 shows a representation of an image sequence for recognizing an object in an item of image information according to one exemplary embodiment of the present invention.

FIG. 13 shows a representation of a capture of a light signal by a multiple exposure according to one exemplary embodiment of the present invention.

FIG. 14 shows a list of subareas used for the read-out of items of subimage information according to one exemplary embodiment of the present invention.

FIG. 15 shows a list of inflection points used in the subareas according to one exemplary embodiment of the present invention.

FIG. 16 shows a list of inflection points and subareas used according to one exemplary embodiment of the present invention.

### DETAILED DESCRIPTION

In the following description of advantageous exemplary embodiments of the present invention, identical or similar reference numerals are used for the elements which are shown in the various figures and act similarly, a repeated description of these elements being omitted.

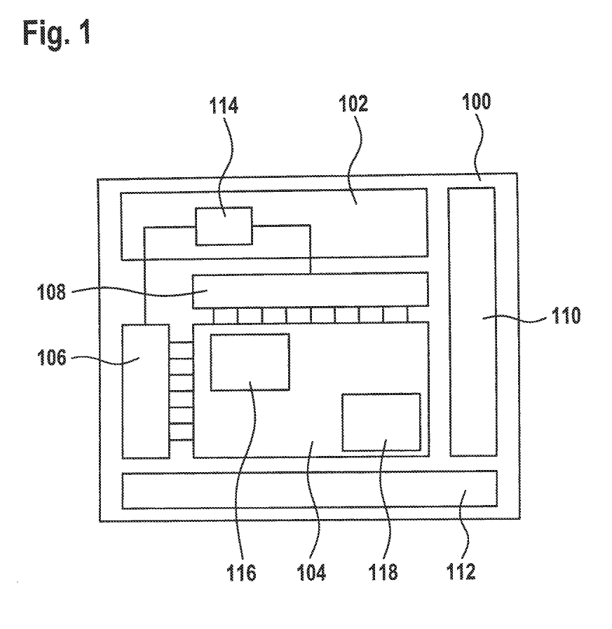

FIG. 1 shows a block diagram of an image sensor 100 including a control unit 102 for operating image sensor 100 according to one exemplary embodiment of the present invention. Image sensor 100 is configured to provide an image file, which represents an image projected on image sensor 100. For this purpose, image sensor 100 has a sensor surface 104, which is constructed from light-sensitive pixels, which are situated in rows and columns. The pixels thus form a matrix. The pixels are addressed by a row controller 106 and a column controller 108. Control unit 102 is situated on a circuit board of image sensor 100. Furthermore, a power supply 110 and analog modules 112 are situated on the circuit board. Control unit 102 has a device 114 for the read-out, which is configured to read out the pixels of a first subarea 116 of sensor surface 104 of image sensor 100, to obtain an item of first subimage information using a first parameter set. Device 114 for the read-out is furthermore configured to read out pixels of at least one second subarea 118 of sensor surface 104 of image sensor 100 to obtain an item of second subimage information using a second parameter set. The second parameter set is different from the first parameter set. A dimension of first subarea 116 and of second subarea 118 is adaptable specifically to the application. Sensor surface 104 may be read out in rows or columns. For the read-out, device 114 is connected to row controller 106 and column controller 108. Device 114 for the read-out outputs signals, which activate row controller 106 and column controller 108. Device 114 for the read-out also receives signals, which represent intensity values of the pixels. These signals are processed using the parameter sets to obtain the items of subimage information.

In one exemplary embodiment, the first parameter set represents at least one first exposure time for the pixels of first subarea 116. Alternatively or additionally, the first parameter set represents at least one first sensitivity characteristic curve for the pixels of first subarea 116. The second parameter set represents at least one second exposure time for the pixels of second subarea 118. Alternatively or additionally, the second parameter set represents at least one second sensitivity characteristic curve for the pixels of second subarea 118.

An exposure controller 102 for a sensor 100 is provided. A sensor 100 is an image sensor 100 in CMOS technology in this case including, for example, a rolling shutter architecture and a high dynamic range technology including a partially linear characteristic curve. The partially linear characteristic curve is implemented by multiple inflection points. Such sensors 100 may be used in most automotive video cameras.

The approach introduced here improves controller 102 of sensor 100 and thus improves the performance capability of sensor 100.

Such an image sensor, 100 may also be referred to as an imager 100, imager sensor 100, or CMOS imager 100.

Controller 102 of image sensor 100 may include a hardwired logic, a configurable logic, and a programmable microcontroller 114. Controller 102 is typically a combination of these elements.

FIG. 1 shows the block diagram of an image sensor 100.

The approach introduced here may be implemented as an alteration of controller 102 (control and interface) of image sensor 100.

Controller 102 of image sensor 100 controls image field 104 including the pixels (pixel array) via row controller 106 (row control) and column controller 108 (column control).

The performance capability of sensor 100 is improved by the approach introduced here. The image is divided into areas 116, 118, in which different exposure settings and exposure times may be used simultaneously, which results in better assistance of applications having multiple functions executed in parallel. This results in a general functional improvement in demanding exposure scenarios, since the requirements of the individual functions for the exposure may be taken into consideration better. Overlapping subareas 116, 118 are also enabled by a double exposure of subareas 116, 118.

The multiple exposure of subareas 116, 118 of the image is a further flexible feature of controller 102 of image sensor 100. The multiple exposure of subareas 116, 118 assists an analysis of the frequency of light sources and results in an improvement of the performance capability of functions which may use the parameter of frequency of a light source. This applies, inter alia, to light controllers.

The multiple exposure of subareas 116, 118 of the image and improved processing of the recorded data improves the recognition of variable message signs. This results in an improvement of the functions for traffic sign recognition.

The multiple exposure of subareas 116, 118 of the image and improved processing of the recorded data improves the recognition of LED traffic lights. This results in an improvement of the functions which are directed to the recognition of traffic lights.

All parts of the approach introduced here may be used independently of one another in an image sensor 100 at the same time.

The approach introduced here may be implemented in particular in the case of sensors configured having a rolling shutter architecture. The terms rolling shutter and global shutter describe the type of the exposure of the individual rows.

The approach introduced here cannot be implemented by a software change, but rather requires adaptations of the hardware of image sensor 100. Sequence controller 102 of image sensor 100 has to be adapted. No adaptations of the pixel technology are required for the approach introduced here.

For example, the recognition of traffic lights may be improved by the introduced approach. It is known from night-vision projects that LED traffic lights have heretofore only been able to be recognized to a limited extent. Difficulties sometimes exist in the recognition of individual types of variable message signs. The type of the variable message sign describes the way in which the LEDs are operated. In other words, the number of the functions on the camera increases and the advantages of the bimodal regulation for individual functions decrease.

The expressions “exposure of an image” and “recording of an image” may be used synonymously.

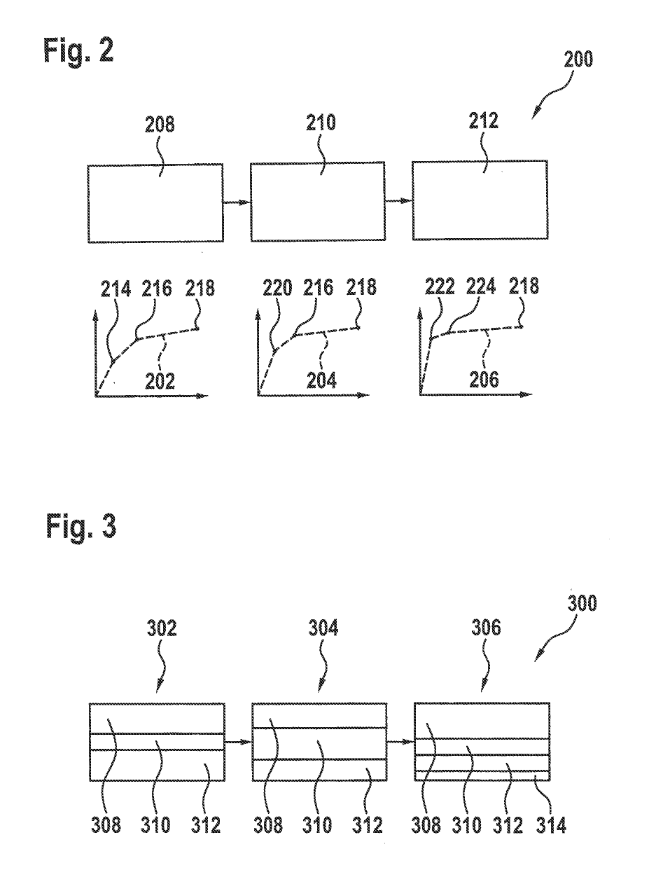

FIG. 2 shows a representation of a sequence for generating an image stream 200 while using various exposure characteristic curves 202, 204, 206. Three images 208, 210, 212 of image stream 200 are shown in the illustrated example. Images 208, 210, 212 are captured successively by an image sensor. First image 208 is captured using a first exposure characteristic curve 202. Second image 210 is captured using a second exposure characteristic curve 204. Third image 212 is captured using a third exposure characteristic curve 206. Exposure characteristic curves 202, 204, 206 represent a ratio between a luminous intensity actually received on the image sensor and a depiction of the luminous intensity in gray scale values of images 208, 210, 212. In particular low luminous intensities are depicted over a large range of the gray scale values. With increasing luminous intensity, large changes in the luminous intensity are depicted in small changes in the gray scale values. In other words, a contrast increase results at low luminous intensities.

Exposure characteristic curves 202, 204, 206 have inflection points 214, 216, 218, 220, 222, 224, to obtain partially linear characteristic curves 202, 204, 206. First exposure characteristic curve 202 has three inflections at a first inflection point 214, at a second inflection point 216, and at a third inflection point 218. Second exposure characteristic curve 204 has three inflections at a fourth inflection point 220, at second inflection point 216, and at third inflection point 218. Third exposure characteristic curve 206 has three inflections at a fifth inflection point 222, at a sixth inflection point 224, and at third inflection point 218.

In the case of CMOS sensors, a linear exposure controller and high dynamic range technology having partially linear characteristic curve 202, 204, 206 may be used. Partially linear characteristic curve 202, 204, 206 is implemented by multiple inflection points 214, 216, 218, 220. High dynamic range technology is abbreviated with HDR. HDR means high dynamic range. HDR is a technology for use of a higher dynamic range.

Sensors having high dynamic range technology are referred to as HDR sensors. HDR sensors implement a partially linear characteristic curve 202, 204, 206 by way of the use of inflection points 214, 216, 218, 220. In this technology, the pixels are not exposed with a fixed exposure time, but rather partially reset multiple times. During the reset, the voltage of the pixel is reset to the reset voltage of inflection point 214, 216, 218, 220. The exposure then begins again at the reset voltage. A partially linear characteristic curve 202, 204, 206 is thus implemented.

HDR sensors may be used in video cameras for automobile usage.

If HDR sensors are used in multifunction cameras or a camera having multiple functions, such as lane recognition, traffic sign recognition, and/or object recognition, the various functions have different requirements for the regulation of the exposure. The regulation of the exposure relates to a setting of the exposure time, the sensor parameters, and the partially linear characteristic curve. The regulation may only be optimized for one function in the previously known approaches. A compromise is necessary in the case of multiple functions. Since this compromise is suboptimal and does not assist optimal implementation of the individual functions, a multimodal regulation may be used.

A multimodal regulation divides the image stream 200 into substreams 208, 210, 212, as are shown, for example, in FIG. 2. For example, image stream 200 is divided into all even and all odd images or more generally every nth image. These subimage data streams 208, 210, 212 are regulated individually. By way of this approach, either the image repetition rate of the subimage data streams is reduced or the image repetition rate of the image sensor may be increased, to achieve the unchanged image repetition rate for subimage data streams 208, 210, 212.

FIG. 2 shows a typical exposure controller. The same exposure controller 202, 204, 206 is used in each of successive images 208, 210, 212 for entire image 208, 210, 212. First exposure setting 202 is used for first image 208. Second exposure setting 204 is used for second image 210. Third exposure setting 206 is used for third image 212. Exposure controller 202, 204, 206 may only be changed from image 208, 210, 212 to image 208, 210, 212. Because of the time required for the read-out and processing of the image data, exposure setting 206 of third image 212 is generally derived from the image data of first image 208. In general, the exposure setting of image N+2 is generally derived from the image data of image N.

The exposure time is identical for all pixels of an image 208, 210, 212 and may be changed from image 208, 210, 212 to image 208, 210, 212. In the example, first image 208 is exposed using a first exposure time T1, second image 210 is exposed using a second exposure time T2, and third image 212 is exposed using a third exposure time T3.

Furthermore, FIG. 2 shows typical characteristic curves 202, 204, 206 which may be used. In the example, two so-called inflection points 214, 216, 218, 220, 222, 224 are used in each case. This means that characteristic curves 202, 204, 206 each include three sections. In general, more inflection points may also be used. The number and configuration of the inflection points may be changed from image to image.

FIG. 3 shows a representation of an image stream 300 made of three successively read out items of image information 302, 304, 306 according to one exemplary embodiment of the present invention. As in FIG. 2, items of image information 302, 304, 306 are successively provided by an image sensor, as shown in FIG. 1, for example. In contrast to FIG. 2, items of image information 302, 304, 306 have items of subimage information 308, 310, 312, 314. Items of subimage information 308, 310, 312, 314 are captured using parameter sets adapted specifically for the application. First item of image information 302 and second item of image information 304 each have three items of subimage information 308, 310, 312. Third item of image information 306 has four items of subimage information 308, 310, 312, 314. The parameter sets of individual items of subimage information 308, 310, 312, 314 are different from item of image information to item of image information. Items of subimage information 308, 310, 312, 314 are of different sizes from item of image information to item of image information. The parameter sets each represent an exposure time and an exposure setting for the particular item of subimage information.

The approach introduced here shows an alternative answer. Image 302, 304, 306 is divided into parts 308, 310, 312, 314 and the exposure of various parts 308, 310, 312, 314 of image 302, 304, 306 is regulated differently. In practice, the same parts of image 302, 304, 306 are not used for the various functions. Therefore, various parts 308, 310, 312, 314 of image 302, 304, 306 also have different requirements.

An improved consideration of the various requirements of the individual functions of a multifunction camera for the exposure regulation is thus achieved, without undersampling by subimage data streams, as takes place in FIG. 2, and without the image repetition rate of the image sensor having to be significantly increased.

For this purpose, image 302, 304, 306 is divided into areas 308, 310, 312, 314, in which different exposure settings and exposure times may be used simultaneously.

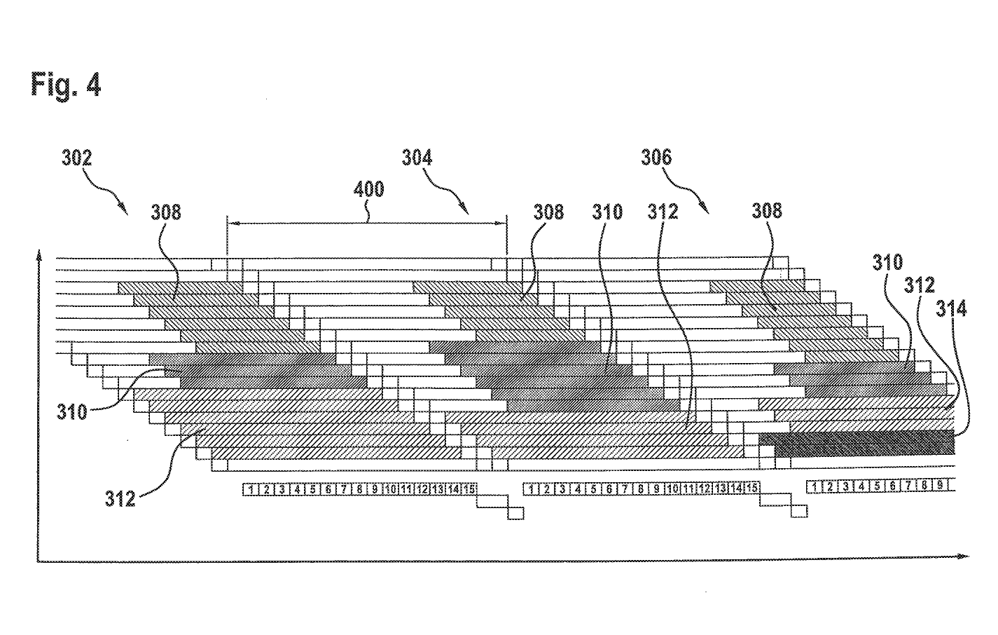

FIG. 4 shows a chronological sequence of an activation of an image sensor according to one exemplary embodiment of the present invention. The activation is shown in a graph, which has the time plotted on the abscissa and the rows of the image sensor, for example, as shown in FIG. 1, plotted on the ordinate. For simplification, the image sensor only has 15 rows in the example shown here. The chronological sequence corresponds to the items of image information in FIG. 3. First item of image information 302 is read out from the rows of the image sensor with a slight chronological offset from row to row. A read-out using a “rolling shutter” is shown. A row is begun with a row beginning and ending with a row end. An exposure of the row is carried out toward the row end. When the exposure time is shorter than maximum time 400 per image, a holding time is subsequently waited out at the row beginning until beginning the exposure. A row beginning of a second row of the image sensor is offset by a time step in relation to the row beginning of a first row. The row beginning of the particular next row is offset in each case by a time step in relation to the row beginning of the previous row. The row ends of the rows are similarly each offset by the time step. When the row beginning of the last row is carried out, the row beginning of the first row is subsequently carried out again. Second item of image information 304 is read out. In the illustrated exemplary embodiment, before the read-out of the particular first row of an item of image information, two initialization rows are read out as the start of the particular item of image information, and after the last row of the item of image information, a further initialization row is read out as the end of the particular item of image information. After the last row of second item of image information 304 has begun, the sequence begins again in the first row with third item of image information 306.

In first item of image information 302, the first six rows are read out using a first parameter set. The first six rows result in first item of subimage information 308. The next three rows are read out using a second parameter set. These three rows result in second item of subimage information 310. The next six rows are read out using a third parameter set. These six rows result in third item of subimage information 312.

With reference to FIG. 2, the first inflection point, the second inflection point, and the third inflection point are used in first subarea 308. The second inflection point, the third inflection point, the fourth inflection point, and the fifth inflection point are used in second subarea 310. The third inflection point, the fourth inflection point, the fifth inflection point, and the sixth inflection point are used in third subarea 312.

In second item of image information 304, the first five rows are read out using a new first parameter set. The first five rows result in first item of subimage information 308. The next six rows are read out using a new second parameter set. These six rows result in second item of subimage information 310. The last four rows of second item of image information 304 are read out using a new third parameter set. These four rows result in third item of subimage information 312.

The first inflection point, the second inflection point, and the third inflection point are also used in this case in first subarea 308. The second inflection point, the third inflection point, and the fourth inflection point are used in second subarea 310. The third inflection point, the fourth inflection point, the fifth inflection point, and the sixth inflection point are used in third subarea 312.

In third item of image information 306, the first seven rows are read out using a further new first parameter set. The first seven rows result in first item of subimage information 308. The next three rows are read out using a further new second parameter set. These three rows result in second item of subimage information 310. The following three rows are read out using a further new third parameter set. These three rows result in third item of subimage information 312. The last two rows of third item of image information 306 are read out using a fourth parameter set. These two rows result in fourth item of subimage information 314.

The first inflection point and the second inflection point are used in first subarea 308 in this case. The second inflection point, the third inflection point, and the fourth inflection point are used in second subarea 310. The third inflection point, the fourth inflection point, and the fifth inflection point are used in third subarea 312. The third inflection point, the fourth inflection point, the fifth inflection point, and the sixth inflection point are used in fourth subarea 314.

In the case of all items of image information 302, 304, 306, an intermediate step is carried out during the initialization rows, in that new parameters of the parameter sets are calculated. The new parameters are stored before the capture of the next item of image information.

In the case of the approach introduced here, all parts 308, 310, 312, 314 of an image 302, 304, 306 are no longer exposed using the same time and the same characteristic curve.

In FIG. 4, first image 302 is divided into areas 308, 310, 312. Areas 308, 310, 312 are each exposed using different times and settings. In each case, image 302, 304, 306 of the image sensor is shown. The Y axis corresponds to the rows and the X axis corresponds to the columns of the image.

Image 302, 304, 306 is divided into areas 308, 310, 312, 314. Areas 308, 310, 312, 314 may include at least one row and at most the entire image; all pixels of one row are associated with one area 308, 310, 312, 314. This restriction is derived from the architecture of a rolling shutter image sensor. An area 308, 310, 312, 314 is a group of rows; the number of areas 308, 310, 312, 314 is basically only limited by the number of the rows. Areas 308, 310, 312, 314 may also overlap, rows n, n+2, and n+4 being able to be associated with one area and rows n+1, n+3, and n+5 being able to be associated with another area. The exposure setting and the exposure time are set. For each area 308, 310, 312, 314, the exposure setting and the exposure time are fixed independently. All rows of an area 308, 310, 312, 314 are exposed using the same exposure setting and exposure time. All pixels of a row are exposed identically, since all pixels of a row are associated with the same area. The exposure setting and the exposure time may vary from image 302, 304, 306 to image. The division of the areas may vary from image to image. The number of the areas may vary from image to image.

The following simple example shows, on the basis of a traffic sign recognition function and lane recognition function, the advantages of the approach introduced here. A typical conflict between the lane recognition function and the traffic sign recognition is the exposure time in darkness. The lane recognition is to recognize lanes on the road at night and requires the longest possible exposure time. The resulting motion blur and the long exposure time result in blurring of the rows, which is generally rather advantageous for lane recognition, however. In contrast, the traffic sign recognition generally analyzes illuminated signs. An excessively long exposure time causes worsening of the recognition performance here due to the motion blur. The traffic sign recognition would therefore ideally set the exposure time at night in such a way that the compromise of motion blur and contrast of the sign are optimal.

Since the lane recognition searches for lanes in the focal point in lower area 312 of image 302 and the traffic sign recognition recognizes traffic signs rather in upper area 308, one may transfer to FIG. 4 and optimize first image 302 depicted therein, for example, third area 312 for lane recognition and first area 308 for traffic sign recognition. Second area 310 would be activated using an exposure usable for both functions. The size and location of second area 310 are adapted to the present driving situation to optimize the overall function.

FIG. 4 shows the implementation in detail on the basis of an image sensor including 15 rows. The small number of 15 rows was selected to be able to explain the principle. The approach may also be used unchanged for image sensors having more rows. There are no specifications or restrictions for the number of rows.

The number of pixels per row is not detailed here, since it has no significance for the approach introduced here. There are no specifications or restrictions for the number of pixels per row.

The embodiment of the characteristic curve in the form of inflection points is not detailed here, since it has no significance for the approach introduced here. There are no specifications or restrictions for the number and configuration of the inflection points per area 308, 310, 312.

The function is shown in a typical image sensor including a rolling shutter architecture. The exposure of the rows of three successive images 302, 304, 306 is shown.

The X axis in FIG. 4 is the time. Image repetition frequency 400 f=1/T results from the time interval of two successive images 302, 304, 306.

The Y axis in FIG. 4 has the rows of the image sensor as a unit. The 15 rows are shown one below another in the figure.

The exposure of the individual rows is shown in the form of areas. The length of the area in comparison to T, i.e., time 400 per image, indicates the exposure time. In FIG. 4, the exposure time is long in areas 312, 314 and shorter in areas 308, 310.

In the rows under the graph, the chronological sequence of the read-out of rows 1 through 15, the calculation of the new regulating parameters for the exposure controller, and the writing of the new parameters in the image sensor are shown.

The rows are processed successively in such an image sensor. This means the rows are successively exposed and read out. This is shown here by way of example for three successive images 302, 304, 306.

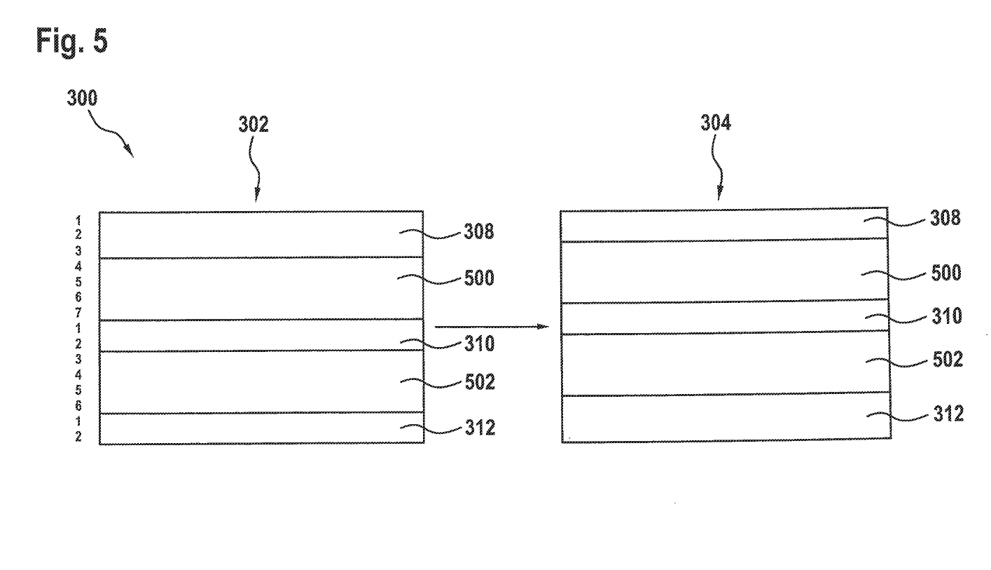

FIG. 5 shows a representation of an image stream 300 including overlapping subareas 308, 310, 312 according to one exemplary embodiment of the present invention. Image stream 300 essentially corresponds to the image stream in FIG. 3. In contrast to FIG. 3, only two items of image information 302, 304 are shown here. Due to the overlap of subareas 308, 310, 312, overlap areas 500, 502 result. The parameter sets of adjacent subareas 308, 310, 312 are superimposed in overlap areas 500, 502.

In other words, an image 302, 304, 306 is divided into areas 308, 310, 312, 314, in which different exposure settings and exposure times may be used simultaneously. Subareas 308, 310, 312, 314 may also be exposed multiple times in this case.

Overlapping areas 500, 502 may also be implemented, in which different exposure settings and exposure times are used simultaneously. For example, a double exposure of subareas 500, 502 of the image is shown.

Subareas 500, 502 may also be exposed multiple times.

In FIG. 5, image 302, 304 is divided into overlapping subareas 308, 310, 312, in which different exposure settings and exposure times may be used simultaneously. One row may be associated with two image areas 308, 310, 312 here. A soft boundary between two areas and therefore different functions is thus achieved.

The use of different exposure settings and exposure times in overlapping area 500, 502 is achieved by a double exposure of overlapping area 500, 502. There are restrictions in this case with respect to the exposure settings and exposure times in overlapping area 500, 502. There is feedback on the chronological sequence of the recording of the entire image 302, 304.

The double exposure of subareas 500, 502 of image 302, 304 does not require a fundamental adaptation of the hardware of the image sensor. The double exposure of subareas of the image is carried out via an adaptation of the controller of the image sensor.

A subarea 308, 310, 312 of the image is a number of immediately successive rows of the image in this case. A subarea is thus the rows from row n to row m of an image. This definition of a subarea 308, 310, 312 differs from the definition of a subarea in the preceding section in the area of the overlap of subareas 308, 310, 312. For rows which are only associated with one subarea, definition 308, 310, 312 from FIG. 3 applies.

In FIG. 5, image 302 is divided into a first area 308, a second area 310, and a third area 312. Areas 308, 310, 312 are each exposed using different times and settings. In each case there is an overlap area 500, 502, which is double exposed, between first area 308 and second area 310 and also second area 310 and third area 312.

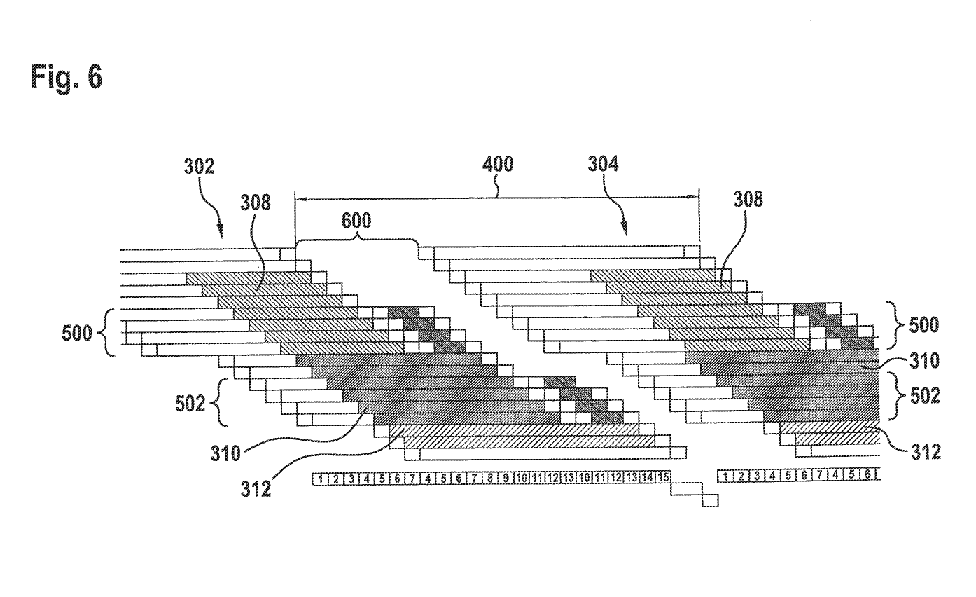

FIG. 6 shows a chronological sequence of an activation of an image sensor using multiple exposure according to one exemplary embodiment of the present invention. The illustrated sequence essentially corresponds to the sequence in FIG. 4. In contrast to FIG. 4, the read-out of items of image information 302, 304 is illustrated as they are depicted in FIG. 5. Overlap areas 500, 502, in which the parameter sets of adjoining subareas 308, 310, 312 overlap, are read out in this case by a multiple exposure within an item of image information 302, 304.

The multiple exposure is carried out by extending time 400 per image. In other words, additional exposure time 600 is inserted between the periods of time for recording items of image information 302, 304. In the illustrated exemplary embodiment, additional exposure time 600 is appended to the normal period of time for exposing the image in two overlap areas 500, 502. Additional exposure time 600 is appended after the row end of the regular exposure time. The row beginning of the following rows is delayed by this period of time by additional exposure time 600. The row end of the rows having multiple exposure and the following normal rows only has the offset by one time step in each case.

First overlap area 500 extends in items of image information 302, 304 from the sixth row up to the ninth row. Second overlap area 502 extends in items of image information 302, 304 from the twelfth row up to the fifteenth row.

FIG. 6 shows, similarly to FIG. 4, the implementation in detail on the basis of an image sensor including 15 rows. The small number of 15 rows was selected to be able to explain the principle. The approach may also be used unchanged for image sensors having more rows. There are no specifications or restrictions for the number of the rows.

For reasons of simplification in the representation, the division of image 302, 304 into subareas 308, 310, 312 and the exposure settings between successive images 302, 304 were not changed in FIG. 6.

In FIG. 6, the feedback on the image recording and the restrictions for the exposure are recognizable. The maximum exposure time for the second exposure of an overlap area 500, 502 is the product of the number of the rows of overlap area 500, 502 and row time 400. Row time 400 TZ represents TZ=1/row frequency here. The division of the image area is defined in such a way that there are n overlapping areas, and the exposure time of the second exposure of overlap areas is T1, T2, . . . Tn. In this case, T increases by the total of times T1, T2, . . . Tn. In practice, the approach introduced here is therefore meaningful in particular when the second exposure takes place only for small subareas 500, 502 having a short exposure time, since total exposure time 400 then only increases slightly. In FIG. 6, time 400 T is increased by 8 row times, one row time being 1/row frequency here. The recording of the rows of the image no longer takes place in equidistant times. Larger gaps result here due to overlap areas 500, 502, in which overlap areas 500, 502 are read out after the second exposure. FIG. 6 shows this in detail between rows seven and eight and rows 13 and 14.

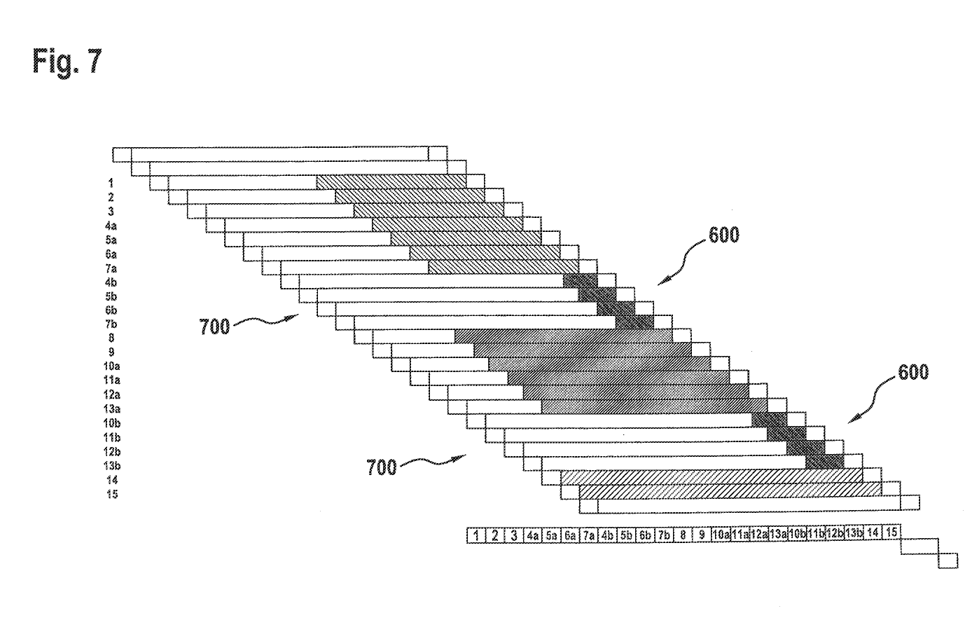

FIG. 7 shows a chronological sequence of an activation of an image sensor including virtual rows 700 according to one exemplary embodiment of the present invention. The chronological sequence shown here essentially corresponds to the chronological sequence in FIG. 6. In contrast thereto, additional exposure time 600 is not subsequently appended to the row end here, but rather situated in virtual rows 700. Virtual rows 700 do not represent physical rows of the image sensor. The virtual rows are used as a placeholder, to be able to integrate additional exposure time 600 into the procedure of the read-out.

The supplementation described here of the approach introduced here furthermore enables the fundamental further use of the existing controller of the image sensor. The detailed concept is described in FIG. 7. The rows are plotted on the Y axis. The concept of the double exposure of subareas 500, 502 may thus be illustrated and explained well.

Alternatively, another representation may be selected. The number of the rows is increased virtually in FIG. 7. Double exposed rows four, five, six, and seven are replaced by rows 4a, 5a, 6a, 7a and 4b, 5b, 6b, and 7b. The procedure is carried out accordingly for rows 10 through 13. Index a indicates the first exposure and index b indicates the second exposure.

The image sensor may also be considered abstractly as an image sensor having 23 instead of 15 rows, in which the double exposed rows are counted twice. For the exposure controller, this means that the same approach as described in the preceding section may be selected. Furthermore, a supplementation of the controller may be implemented, which checks in each case whether the reset voltage for the selected row is valid on the basis of the association of the row with an area and the exposure parameters established for this area.

A maximum exposure time results in this case for the second exposure of an overlap area 500, 502. The maximum exposure time for the second exposure of an overlap area 500, 502 is the product of the number of the rows and row time TZ (the row time is TZ=1/row frequency here). This restriction may be avoided if virtual “blank rows” are incorporated.

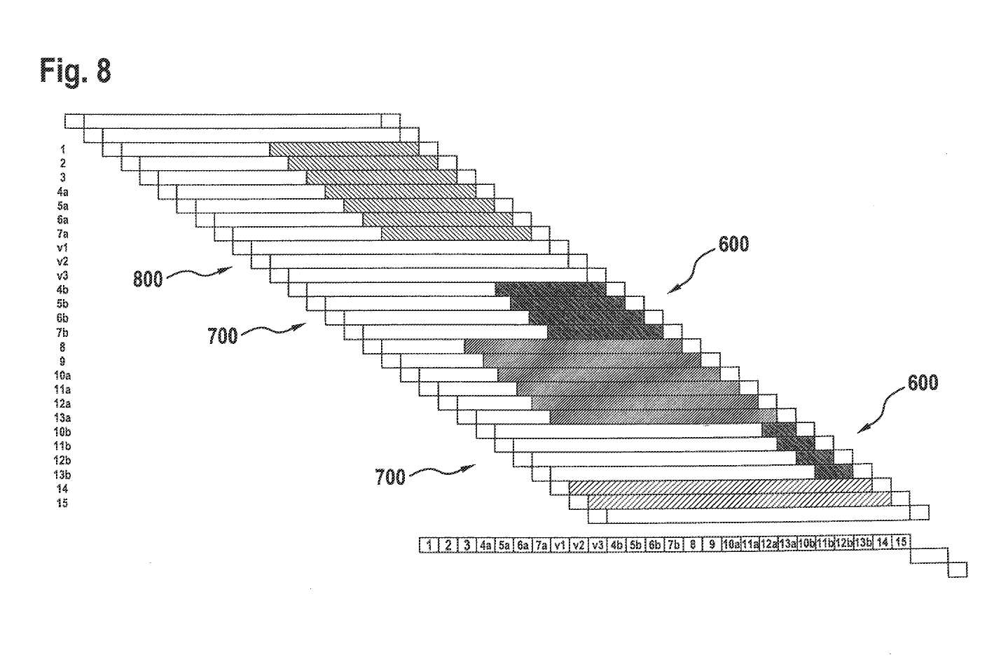

FIG. 8 shows a chronological sequence of an activation of an image sensor including blank rows 800 according to one exemplary embodiment of the present invention. The chronological sequence shown here essentially corresponds to the chronological sequence in FIG. 7. In addition, blank rows 800 are incorporated here between the rows of overlap area 500 and virtual rows 700 having additional exposure time 600. Due to additional blank rows 800, the duration of additional exposure time 600 may be devised more freely, since the beginning of the read-out of additional exposure time 600 may only be carried out subsequently to the row end of the corresponding row of overlap area 500. The individual rows, including blank rows 800 under virtual rows 700, are also each offset by one time step in relation to one another.

To increase the maximum exposure time in overlap area 500, 502 of rows four through seven during the second exposure, three virtual rows v1, v2, v3 are incorporated here. It is to be noted that the approach introduced here makes sense in particular when the second exposure takes place using a short exposure and overlap areas 500, 502 are not excessively large. By incorporating virtual rows 800, the image repetition frequency is reduced further. In an individual case, incorporating virtual rows 800 may be a meaningful procedure, however. The use of virtual rows 800 makes the approach introduced here more flexible and reduces the restrictions in the use.

The rows of the image sensor are divided into areas. Subareas 308, 310, 312 overlap. One row may be associated with one or two subareas 308, 310, 312. The use of different exposure settings and exposure times in overlap area 500, 502 is achieved by a double exposure of the overlap area.

A subarea of image 302 is a number of immediately successive rows of image 302 in this case. A subarea 308, 310, 312 is thus the rows from row n to row m of an image. This definition of a subarea 308, 310, 312 differs from the definition of a subarea in the preceding section. This restriction only applies for area 500, 502 of the overlap of subareas 308, 310, 312. For rows which are only associated with one subarea, the definition from the preceding section applies.

The maximum exposure time for the second exposure of an overlap area 500, 502 is the product of the number of the rows of overlap area 500, 502 and row time TZ, the row time being TZ=1/row frequency here. To be able to expose overlap areas 500, 502 longer during the second exposure, virtual rows may be incorporated at the beginning of the overlap area. These virtual rows virtually enlarge the overlap area.

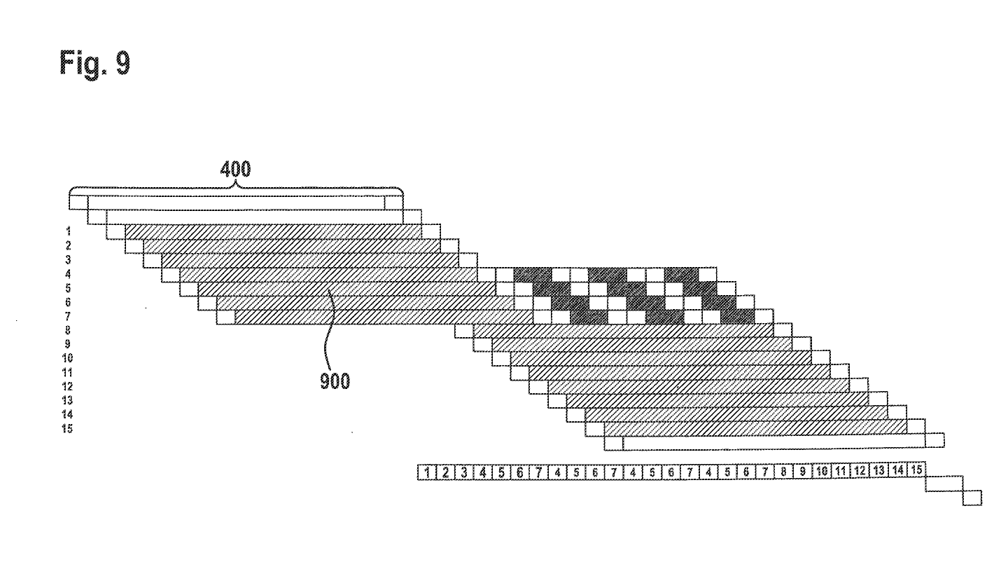

FIG. 9 shows a chronological sequence of an activation of an image sensor using a multiple exposure of an object area 900 according to one exemplary embodiment of the present invention. The sequence essentially corresponds to the sequence in FIG. 4. In addition, an object area 900 is defined here, in which an object has been recognized. Object area 900 extends from the fourth to the seventh row. The object in object area 900 has been classified as a light-emitting object. The object may thus be, for example, a streetlight, which therefore emits its light pulsed at network frequency. The object may also be a vehicle having LED lighting, which emits its light pulsed at high frequency. If the vehicle has a conventional lighting, this lighting is operated using direct current and the light is emitted in a nearly unplanned manner. Therefore, the rows in object area 900 are exposed three times in direct succession for a short time subsequently to normal exposure time 400 in the exemplary embodiment shown. Since these exposure times are established in the range of milliseconds, it may be ascertained at which frequency the light is emitted. It may therefore be differentiated what type of light source the recognized object uses.

An improved analysis of the frequency of light sources is enabled by the approach introduced here. Furthermore, an improved recognition of variable message signs using LED technology and traffic lights using LED technology is enabled.

Subareas 900 of image 302 may be exposed multiple times by the approach introduced here, to be able to analyze the frequency of light sources.

The multiple exposure of subareas of the image does not require a fundamental adaptation of the hardware of the image sensor. The multiple exposure of subareas 900 of image 302 requires an adaptation of the controller of the image sensor.

A subarea 900 of image 302 is a number of immediately successive rows of image 302 in this case. A subarea is thus the rows from row n to row m of an image 302.

An analysis of the frequency of light sources is practically not possible using a conventional image sensor. The reason is that excessively little image data having an excessively low recording frequency are available from the object.

Conventional image sensors typically operate at recording frequencies of 25 Hz to 60 Hz. The typical frequencies of light sources are in the range of 0 Hz to a few hundred hertz. Since the vehicle and the light source are moving, an analysis of the frequency information is only possible to a limited extent.

In the case of the approach introduced here, a repeated exposure of subareas 900 of image 302 is carried out for the analysis of the frequency of light sources. Subareas 900 are recorded multiple times in succession between two images. The exposure time is relatively short. In practically all presently used image sensors, only a short exposure time is necessary for the recording of the light source because of the sensitivity of the image sensors. A long exposure time is necessary for low-contrast objects and objects which are inadequately illuminated in darkness.

FIG. 9 shows the implementation in detail on the basis of an image sensor including 15 rows. The small number of 15 rows was selected to be able to explain the principle. The approach may also be used unchanged for image sensors having more rows. There are no specifications or restrictions for the number of the rows.

Rows four through seven are exposed three times. The figure shows that the multiple exposure is a generalization of the double exposure of the overlap areas described in the preceding section. In general, the selected area may be exposed arbitrarily often in principle. In general, multiple areas of an image may also be exposed multiple times. The configuration of the repeatedly exposed areas and the number of the exposures of the individual areas may be changed from image to image.

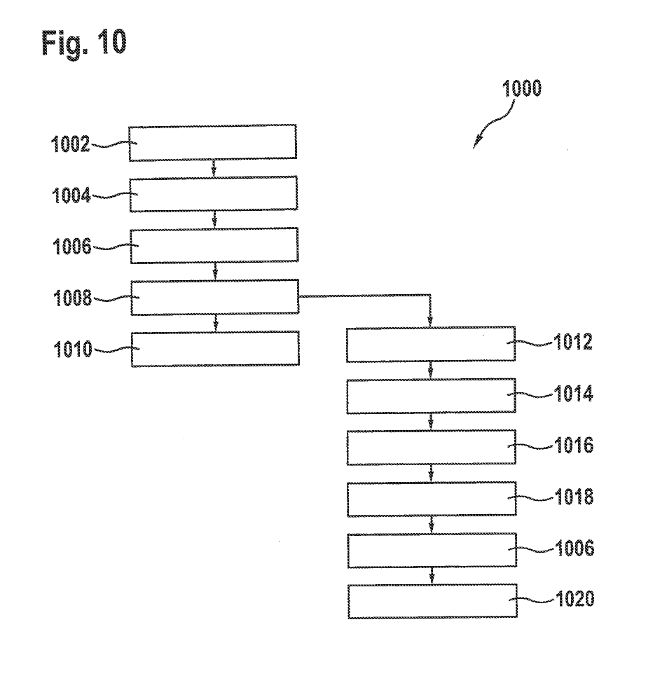

FIG. 10 shows a flow chart of a method 1000 for operating an image sensor according to one exemplary embodiment of the present invention. Method 1000 may be carried out on a control unit, as shown in FIG. 1. Method 1000 has a step 1002 of the read-out. In step 1002 of the read-out, pixels of a first subarea of the image sensor are read out. A first item of subimage information is generated using a first parameter set. In step 1002 of the read-out, furthermore pixels of at least one second subarea of the image sensor are read out. A second item of subimage information is generated using a second parameter set, which is different from the first parameter set.

In one exemplary embodiment, a configuration 1004 of the classification is carried out subsequently to image recording 1002. A classification 1006 is then carried out. An analysis 1008 of the results of the classification is then carried out. In analysis 1008, a differentiation is carried out between conventional traffic signs 1010 and variable message signs 1012. When a variable message sign 1012 has been recognized, a configuration 1014 is carried out for a multiple exposure. The object areas are defined as shown in FIG. 9, for example. A multiple exposure 1016 is then carried out in these object areas. Subsequently thereto, the result of the multiple exposure is added up 1018 and post-processed. A classification 1006 is then again carried out. Classification 1006 outputs as a result a signal content 1020 of the variable message sign.

The basis for the implementation of the approach introduced here is a standard CMOS image sensor. The image sensor has a rolling shutter architecture. The image sensor uses high dynamic range technology including a partially linear characteristic curve. The partially linear characteristic curve is defined by multiple inflection points. The rows of the image sensor are divided into areas. The areas may include at least one row and at most the entire image. All pixels of one row are associated with one area. An area is a group of rows. The number of the areas is basically only limited by the number of the rows of the image sensor. The areas may also overlap. Rows n, n+2, and n+4 may be associated with one area and rows n+1, n+3, and n+5 may be associated with another area.

The division of the image into areas may vary from image to image. The allocation of the areas may vary from image to image. The number of the areas may vary from image to image.

The exposure setting and the exposure time are defined and set independently for each area. The exposure setting and the exposure time per image are defined and set for each area. All rows of one area are exposed using the same exposure setting and the exposure time. All pixels of one row are exposed identically, since all pixels of one row are associated with the same area.

The exposure settings and the exposure times of all areas of the next image to be recorded are transferred to the image sensor for the uniform setting of the exposure setting and the exposure time for the entire image before the beginning of the exposure.

The exposure regulation is carried out as in a standard image sensor including a rolling shutter architecture. All of the image data may be used for defining the areas and the exposure settings and exposure times for the individual areas.

Before the application of a reset voltage of an inflection point, it is checked whether the voltage is valid for the presently processed row. The check is carried out on the basis of the check of the association of the presently processed row with an area and the check as to whether the inflection point with which the reset voltage is associated is active and valid in this area.

A traffic sign recognition algorithm is adapted in such a way that in the case of variable message signs, the individual traffic sign is no longer recognized, but rather the variable message sign is recognized independently of the concrete setting of the variable message sign.

A multiple exposure of the variable message sign is carried out in the area of a recognized variable message sign.

A summation image is calculated from the images recorded with the aid of multiple exposure. This means that for each pixel, the sum is calculated over all individual images. The summation image is post-processed. For example, smoothing is carried out during the post-processing.

The precise traffic sign is determined with the aid of a classification method in the summation image, which is calculated and post-processed from the multiple exposure.

In other words, the approach introduced here describes the adaptation of a rolling shutter by dividing the sensor into various image areas and operating the individual image areas using individual exposure characteristic curves.

The exemplary embodiments which are described and shown in the figures are only selected as examples. Different exemplary embodiments may be combined with one another in their entirety or with reference to individual features. One exemplary embodiment may also be supplemented by features of another exemplary embodiment.

Furthermore, the method steps provided here may be carried out repeatedly and in a sequence different from that described.

If one exemplary embodiment includes an “and/or” linkage between a first feature and a second feature, this is to be read to mean that the exemplary embodiment has both the first feature and also the second feature according to one specific embodiment and has either only the first feature or only the second feature according to another specific embodiment.

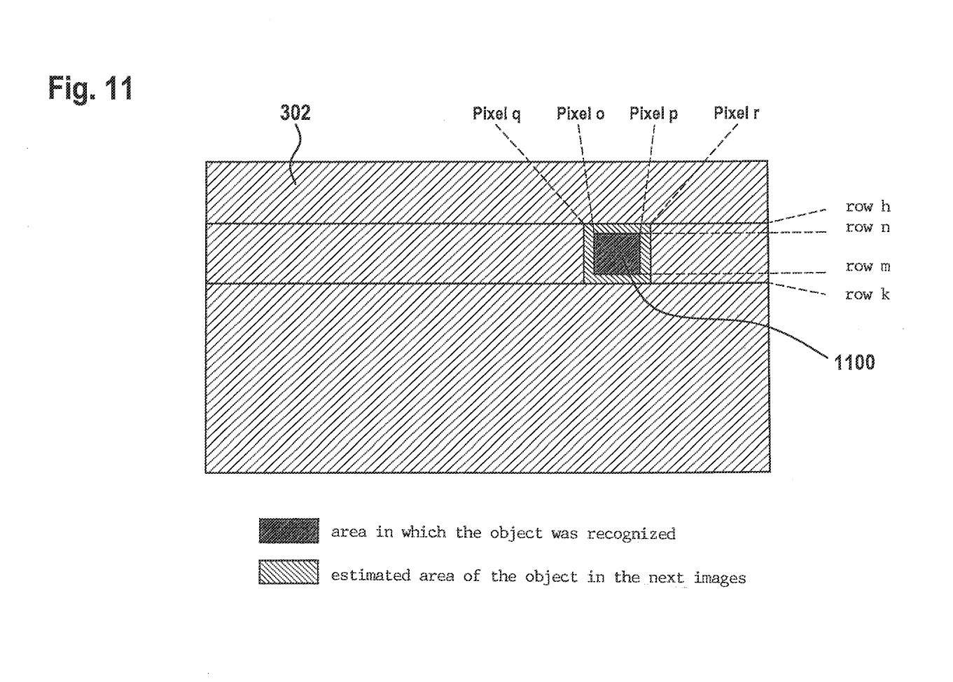

FIG. 11 shows a representation of an object 1100 in an item of image information 302 according to one exemplary embodiment of the present invention. A basic function which is used in many functions is object recognition. Objects 1100 may be, inter alia, vehicles, light sources, or traffic signs. The recognition of objects 1100 is generally carried out in that initially a list of possible objects is prepared based on image data 302. This list is often referred to as the candidate list. Candidate means that it is a possible object 1100, and a further examination is necessary. In a further step, features are generally determined for the individual candidates.

Features may be, for example, the size, the color, and the movement over multiple images. Another feature is the frequency of the light source. For example, it is possible with the aid of this feature to differentiate between DC light sources, for example, halogen headlights in oncoming vehicles, and AC light sources, for example, streetlights in municipalities. The frequency of the light source in this example is either 0 Hz in the case of a DC light source or 50 Hz/60 Hz in the case of an AC light source, which is operated on the public network, in most countries of the world.

In the illustrated example, the object recognition has recognized an object 1100 in the area of rows n to m in the area of pixels o to p. It is estimated that the object will be located in the next images in the area of rows h to k in the area of pixels q to r. Rows h to k are therefore recorded multiple times between images N and N+1. In this example, the rows are recorded three times. The value three is an example and may be selected arbitrarily in principle.

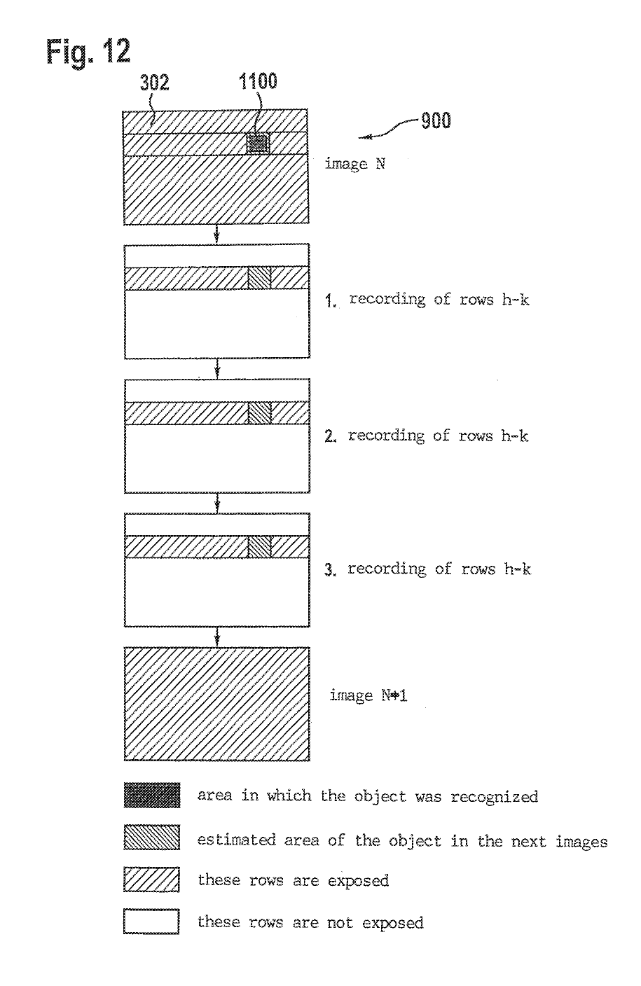

FIG. 12 shows a representation of an image sequence for recognizing an object in an item of image information according to one exemplary embodiment of the present invention. The sequence of the multiple recording of selected subarea 900 is shown. In the example, rows h to k are selected subarea 900.

The rows after subarea 900, which is recorded multiple times, are recorded with a time delay. This is a consequence of the rolling shutter architecture.

To integrate the multiple recording of subareas 900 into the exposure controller, multiple procedures are possible. For example, a regular sequence may be defined, during which a subarea 900 is recorded x times every M images. Multiple recordings may be initiated by a function if needed.

The controller of an image sensor including a rolling shutter architecture also has a normal latency in the case of multiple exposure of subareas. A multiple recording of subimages after image N+2 may be carried out on the basis of the analysis of the image data of image N+1. This is the earliest possible case. In the event of a greater latency of the analysis algorithms, the multiple recording may be carried out on the basis of the image data of image N.

Multiple subareas in one image may also be exposed multiple times. There are no restrictions with respect to the number of subareas 900 and the number of the recordings. It is basically possible that subareas 900 overlap. Permitting the overlap of the subareas results in a higher complexity of the controller of the image sensor.

Subareas 900 are selected which are to be exposed multiple times. Selected subareas 900 of image 302 are, in this exemplary embodiment, a number of directly successive rows of image 302. A subarea 900 thus includes the rows from row n to row m of an image 302.

Selected subareas 900 are exposed multiple times. The maximum exposure time for the multiple exposure of such a subarea 900 is the product of the number of the rows of subarea 900 and the row time, which corresponds to 1/row frequency here. To be able to expose subareas 900 longer during the multiple exposure, virtual rows may be incorporated at the beginning of subarea 900 before each exposure. These virtual rows virtually enlarge subarea 900.

The frequency of the light sources is calculated from the recorded image data by way of an analysis of the differences between the successively recorded images or by way of a frequency analysis.

The multiple exposure of subareas may also be used for improved recognition of variable message signs and traffic lights using LED technology. The improvement is achieved for variable message signs and traffic lights, which are configured using LED technology and in which the LEDs are operated in the pulsed mode.

The procedure is identical for variable message signs and traffic lights. When a variable message sign is referred to hereafter, this may also be understood to include a traffic light.

There are variable message signs in which the LEDs of the message sign are operated synchronously. In this case, the difficulty is that the LEDs are all off and the message sign therefore may not be recognized with a certain probability in the recorded image. Since only a few images may be recorded during the approach to the message sign because of the speed, and the image repetition frequency of available image sensors and typical algorithms require a sequence of images to be able to recognize message signs, the recognition rate of variable message signs may drop.

There are variable message signs in which the LEDs of the message sign are not operated synchronously. In this case, the difficulty is that generally only a part of the sign is visible in the recorded image and therefore the message sign cannot be recognized.

The approach introduced here improves the recognition of variable message signs by the multiple exposure of relevant areas in the image and by an adapted exposure controller and analysis of the image data.

A traffic sign recognition function operates similarly to a typical object recognition in the sense that candidate lists of possible traffic signs are prepared. These candidates are tracked over multiple images and it is checked whether a sign may be recognized sufficiently reliably. A traffic sign recognition function therefore checks the candidate list for plausibility on the basis of ambient data, for example, the course of the road on the basis of a recognized lane and the location of the horizon on the basis of a horizon estimation.

A traffic sign recognition function attempts to recognize the specific sign. In the case of a candidate it is thus checked, for example, whether a 50 km/h sign, a 60 km/h sign, or a sign having another speed setting is present. In the case of a traffic light, a red, a yellow, a red-yellow, or a green traffic light is accordingly searched for.

On the basis of the above-described pulsed operating mode of the LEDs, the classification may not result in a positive result in many cases, since the variable message signs cannot be completely recognized in the recorded images.

In the approach introduced here, the classification no longer searches for a traffic sign having a precise speed indication, but rather only in general for a variable message traffic sign having any arbitrary speed indication. With respect to the traffic light, a traffic light having any arbitrary setting is sought. It is simpler to determine reliable candidates due to this generalization.

The pulsed LED variable message signs result in incomplete sign depictions in the recorded images. For example, only the upper area of the sign is displayed, when only the LEDs in the upper area were on during the recording. These incomplete sign depictions may be learned for the classification. However, since the incomplete sign depictions differentiate less strongly between the various signs to be recognized than complete sign depictions and since in this case there are many more possible depictions of the sign, the classification becomes more complex and the differentiability of the various signs by the classification is reduced. Combining the various sign types to form a sign group results in a variable message sign group which may be recognized or classified better.

As soon as a good candidate for a variable message sign has been determined, a multiple exposure of area 900 in which the variable message sign was recognized is carried out.

The specific traffic sign is determined using the data of the multiple exposure. This means that the precise speed indication is determined. Transferred to the traffic light, in this step the precise setting of the traffic light is determined from the data of the multiple exposure.

The use of inflection points is not very suitable for recording pulsed light sources. The use of one exposure having an exposure time T without the use of inflection points is more suitable. Since the multiple exposure is only carried out for the variable message signs, a normal exposure without inflection points may be used during this procedure. The exposure time is selected in such a way that an LED which is on during the entire exposure time does not yet result in an overmodulation.

The image data of the individually recorded images is added up pixel by pixel to determine the precise traffic sign from the image data of the multiple exposure. The dark areas of the sign, on which no LEDs are located, remain dark. The areas in which LEDs are located are assembled in the entire image from the subareas of the sign which were recorded in individual images. Since not all LEDs in the images were recorded for an equal length of time in total, the subareas of the sign are differently bright in the assembled image under certain circumstances. Smoothing of these differences may be carried out as post-processing. An algorithm may be used for this purpose, which summarizes the large gray scale value range of the LEDs of the variable message sign in a small gray scale value range. Finally, the precise traffic sign is determined from the processed image with the aid of classification.

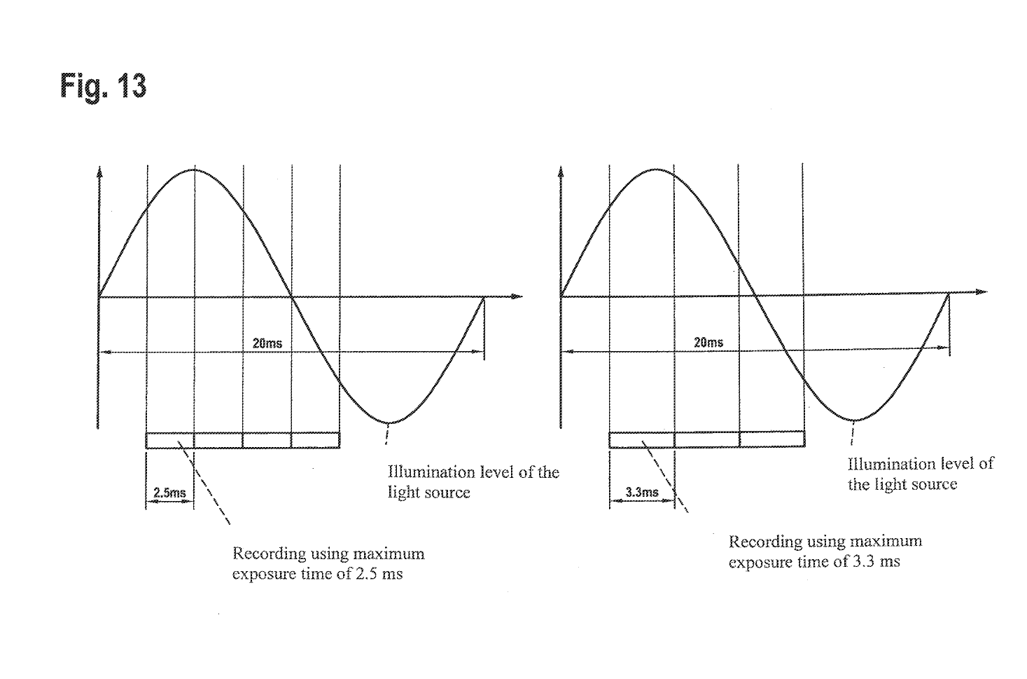

FIG. 13 shows a representation of an acquisition of a light signal by a multiple exposure according to one exemplary embodiment of the present invention. The image data of the multiple recordings of the subarea are used for the analysis of the frequency of the light source.

The image data may be analyzed using various methods. In one exemplary embodiment, the analysis is carried out with the aid of the evaluation of the differences between the successive subimages in the area of the light source. The sum of the differences between the pixels of each two successive images is added up.

In the case of DC light sources, the subareas remain relatively constant and the result is small. Only the noise and the changes in the scenery as a result of the movements of the vehicle and the changes in the surroundings contribute. To reduce the influence of the changes in the scenery, low-pass filtering is carried out before the summation.

In the case of AC light sources, the change of the light source contributes. The result is greater.

The exposure time of the subimages is adapted in this procedure to the frequency of the light source.

For the duration of an oscillation, T=20 ms (T=1/f) applies for the recognition of AC light sources having a frequency of 50 Hz.

For example, the sinusoidal curve of the brightness of a 50 Hz light source over a period of 20 ms and the recording of the light source using multiple exposure are shown. The x axis depicts the time and the y axis depicts the illumination level of the light source.

To sample the light source in the on state and in the off state and to ensure what may be great differences between two successive images, sampling is carried out at a frequency of greater than 4/T. A time of at least 2/T should be sampled.

In a first example, five images are recorded at a frequency f=8/T and a recording duration of T=2.5 ms. Sampling is carried out for a total of 10 ms. In a second example, four images are recorded at a frequency f=6/T and a recording duration of T=3.33 ms. Sampling is also carried out for a total of 10 ms here.

AC light sources having a frequency of 50 Hz to 60 Hz appear worldwide in many fields. Due to the increasing propagation of LED lights, these lights are also to be taken into consideration. LED lights generally operate at higher frequencies.

A frequency analysis is carried out in another exemplary embodiment. The analysis is carried out with the aid of a frequency analysis of the core area of the light source. The determination of the core area is carried out beforehand by the algorithm of the corresponding function.

A small area in the center of the light source is selected. The small area, which only includes a few rows, enables a greater number of images to be recorded in a shorter time. Eight or 16 images are recorded. The mean value of the core area of the light source is calculated per image. The calculated mean value is a measure of the illumination level of the light source at the point in time of this recording.

The mean values are analyzed with the aid of a method for spectral analysis. Suitable methods are, inter alia, DFT (discrete Fourier transform) or FFT (fast Fourier transform). The frequency of the light source may be derived from the result of the spectral analysis.

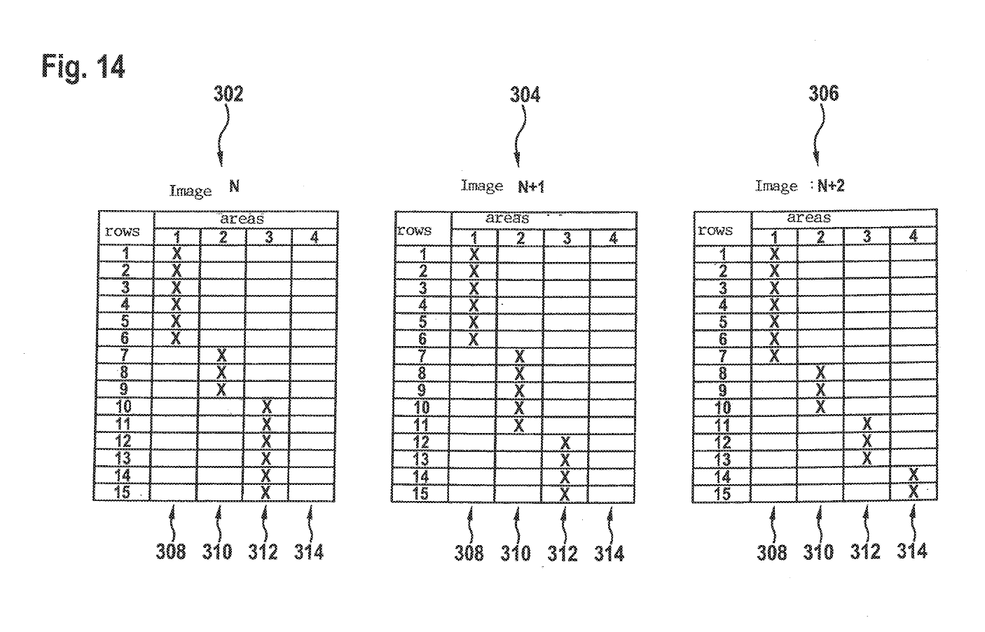

FIG. 14 shows a list of subareas 308, 310, 312, 314 used to read out items of image information 302, 304, 306 according to one exemplary embodiment of the present invention. The list is in the form of a table. A separate table is shown for each item of image information 302, 304, 306. The tables essentially show the same information as shown in the graph in FIG. 4. Subareas 308, 310, 312, 314 are plotted on the horizontal axis of each table in this case. Rows 1 through 15 of the image sensor are plotted on the vertical axis of the table in FIG. 4.

In other words, FIG. 14 shows a table which shows the association of the rows with areas 308, 310, 312, 314 as an example. FIG. 14 is oriented to the example from FIG. 3.

The example in FIG. 14 describes the definition of areas 308, 310, 312, 314 for an imager having 15 rows in three successive images 302, 304, 306.

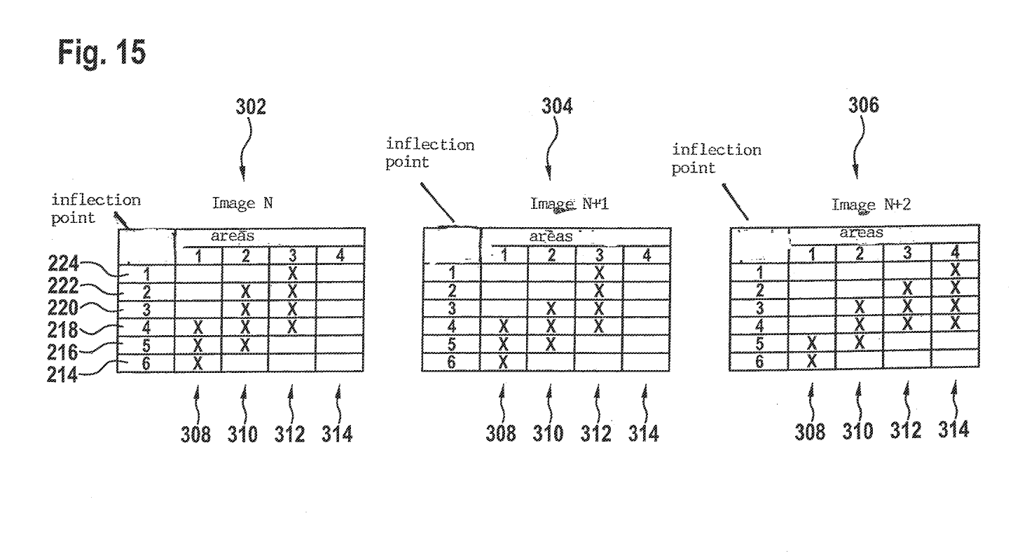

FIG. 15 shows a list of inflection points used in the subareas according to one exemplary embodiment of the present invention. In an image sensor, there are generally restrictions for the parameterization of inflection points 214, 216, 218, 220, 222, 224. These restrictions may relate to the integration times of the inflection points and the voltages of the inflection points. The background of the restrictions is that the inflection points are settable for all rows of the image sensor on the basis of the hardware resources provided in the image sensor. In the implementation of the approach introduced here, all inflection points 214, 216, 218, 220, 222, 224 used in various areas 308, 310, 312, 314 per image 302, 304, 306 are to be considered as a single set of inflection points. This one set of inflection points may maintain the restrictions for the parameterization as a whole. The approach introduced here may therefore be implemented without fundamental hardware changes being necessary.

It follows from the use of multiple image areas 308, 310, 312, 314 and the consideration of the above-described rule that in the implementation of the approach introduced here, either the number of the inflection points used increases or fewer inflection points may be used in the individual areas.

It is expected from experience that this restriction does not have great significance. Basically, the same inflection points 214, 216, 218, 220, 222, 224 may be used in various areas 308, 310, 312, 314. Fewer inflection points are required in individual areas 308, 310, 312, 314, since the areas are optimized more strongly for a few functions. However, it is to be ensured in the configuration of the image sensor that the number of the inflection points of the image sensor is not excessively low.

The definition of the individual areas and the parameters for the exposure controller and exposure times for the individual areas are each stored in the image sensor before the start of the exposure of a new image. Thus, nothing is changed by the present invention with respect to the sequence in the user interface. In the approach introduced here, the parameters are stored for all areas 308, 310, 312, 314. The data remain valid until new parameters are stored, as previously. The acceptance of the new parameters is carried out in each case at the beginning of the exposure of a new image.

The exposure regulation is carried out as in a standard image sensor including a rolling architecture. All of the image data may be used for defining the areas and the exposure settings and exposure times for the individual areas.

In an image sensor having high dynamic range technology including a partially linear characteristic curve, the partially linear characteristic curve is implemented by multiple inflection points. The controller of the image sensor applies the defined reset voltage to the pixels of the present row in this case for each inflection point at the defined point in time. This is carried out for all inflection points in succession for all rows of the image sensor.

Considered abstractly, the inflection points of all areas of the image are together a set of inflection points for the entire image. The controller processes all inflection points and basically applies them to the entire image, i.e., all rows of the image. It is then decided for each row and each inflection point before the application of the reset voltage whether the reset voltage is valid for this row. This is carried out on the basis of the association of the row with an area and the exposure parameters defined for this area.

This procedure enables the fundamental further use of the existing controller of the image sensor. A supplementation of the controller is implemented, which checks in each case whether the reset voltage is valid for the selected row on the basis of the association of the row with an area and the exposure parameters defined for this area.

In other words, FIG. 15 shows a table which shows the definition of inflection points 214, 216, 218, 220, 222, 224 for individual areas 308, 310, 312, 314 as an example. FIG. 15 is oriented to the example from FIG. 3. This table is derived in the controller of the image sensor from the configuration data. The table is derived again for each image.

The example in FIG. 15 describes the association of inflection points 214, 216, 218, 220, 222, 224 of areas 308, 310, 312, 314 for an imager having 15 rows in three successive images 302, 304, 306. In the example, the 15 rows are associated with three to four areas and in total six inflection points are used, of which a selection is used in each of the individual areas. This table is derived in the controller of the image sensor from the configuration data. The table is derived again for each image.

The two tables from FIGS. 14 and 15 are combined for the controller of the exposure of the image, to determine whether an inflection point is valid for a specific row.

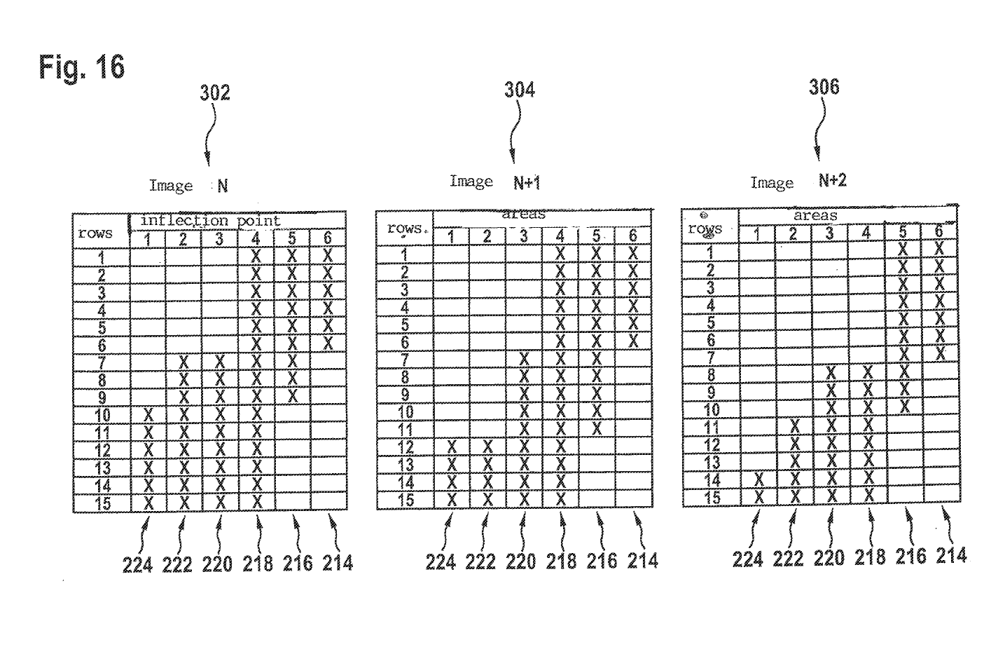

FIG. 16 shows a list of inflection points 214, 216, 218, 220, 222, 224 used in subareas 308, 310, 312, 314 according to one exemplary embodiment of the present invention. The list is in the form of a table. A separate table is shown for each item of image information 302, 304, 306.

In FIG. 16, this is shown as an example for images N, N+1, and N+2 from FIGS. 14 and 15 in the form of a table.

The control of the exposure of the image sensor is carried out on the basis of the concept illustrated on the basis of FIGS. 14, 15, and 16. The controller may decide on the basis of the table in FIG. 16 for each row and each inflection point whether or not the reset voltage has to be applied, and therefore may control the exposure of the image sensor in accordance with the configuration. For each application of a reset voltage of an inflection point, it is to be checked whether this voltage is valid for the presently processed row.

What is claimed is:

1. A method for operating an image sensor, which has pixels situated in rows and columns, the method comprising:
reading out pixels of a first subarea of the image sensor to obtain a first item of subimage information using a first parameter set; and
reading out pixels of at least one second subarea of the image sensor to obtain a second item of subimage information using a second parameter set, which is different from the first parameter set.

2. The method of claim 1, wherein in the reading out, the pixels of the first and/or second subarea are read out row by row, the read-out of a last row of the first subarea being ended chronologically after a beginning of the read-out of a first row of the second subarea.

3. The method of claim 1, wherein the reading out, the pixels of the first and/or second subarea are read out row by row, the read-out of a second row of the first subarea being ended chronologically after an end of the read-out of the first row of the second subarea.

4. The method of claim 1, wherein in the reading out, the first parameter set represents at least one first exposure time for the pixels of the first subarea and/or at least one first sensitivity characteristic curve for the pixels of the first subarea and the second parameter set represents at least one second exposure time for the pixels of the second subarea and/or at least one second sensitivity characteristic curve for the pixels of the second subarea.

5. The method of claim 1, wherein in the reading out, the first subarea is read out with a first number of rows and the second subarea is read out with a second number of rows, the first number of rows and the second number of rows being variable specifically for the application.

6. The method of claim 1, wherein in the reading out, the first subarea is read out with a first number of columns and the second subarea is read out with a second number of columns, the first number of columns and the second number of columns being variable specifically for the application.

7. The method of claim 1, wherein in the reading out, the first item of subimage information and the second item of subimage information are joined to form an item of image information.

8. The method of claim 7, wherein in the reading out, the image sensor is read out cyclically and an image stream is assembled using a plurality of items of image information, the read-out of a last row of a preceding item of image information of the image stream being started before the read-out of a first row of a subsequent item of image information of the image stream, the read-out of the last row of the preceding item of image information being stopped after the start of the read-out of the first row of the subsequent item of image information.

9. The method of claim 8, wherein in the reading out, the preceding item of image information is read out using the first parameter set and at least the second parameter set, the following item of image information being read out using a further first parameter set and at least one further second parameter set.

10. A control unit for operating an image sensor, which has pixels arranged in rows and columns, comprising:
a device to read out pixels of a first subarea of the image sensor, to obtain a first item of subimage information using a first parameter set, and to read out pixels of at least one second subarea of the image sensor, to obtain a second item of subimage information using a second parameter set, which is different from the first parameter set.

11. An image sensor, comprising:
a control unit for operating an image sensor, which has pixels arranged in rows and columns, including:
a device to read out pixels of a first subarea of the image sensor, to obtain a first item of subimage information using a first parameter set, and to read out pixels of at least one second subarea of the image sensor, to obtain a second item of subimage information using a second parameter set, which is different from the first parameter set.

12. The image sensor of claim 11, wherein in the reading out, the pixels of the first and/or second subarea are read out row by row, the read-out of a last row of the first subarea being ended chronologically after a beginning of the read-out of a first row of the second subarea.

13. A machine-readable storage medium having a computer program, which is executable by a processor, comprising:
a program code arrangement having program code for operating an image sensor, which has pixels situated in rows and columns, by performing the following:
reading out pixels of a first subarea of the image sensor to obtain a first item of subimage information using a first parameter set; and
reading out pixels of at least one second subarea of the image sensor to obtain a second item of subimage information using a second parameter set, which is different from the first parameter set.
